(19) United States
(12) Patent Application Publication
(10) Pub. No.: US 2006/0138223 A1
(43) Pub. Date: Jun. 29, 2006

(54) Shipping information acquisition device and usage

(76) Inventor: Brian A. Schar, Menlo Park, CA (US)

Correspondence Address: Brian Schar, 720 Laurel Avenue, Menlo Park, CA, 94025, US

(21) Appl. No.: 11/021,696

(22) Filed: Dec. 23, 2004

(51) Int. Cl. G07B 15/02

(52) U.S. Cl. 235/384

(57) ABSTRACT

A shipping information acquisition device may include a system that positively identifies the receiver of a package, a system that acquires information associated with delivery of a package, a system that acquires information associated with the receipt of a package from a sender, and/or other information. Information associated with the package, its receiver and/or sender may be stored in a composite data record. The composite data record may be stored and later retrieved to facilitate tracking data associated with packages.

### FIELD OF THE INVENTION

The present invention relates generally to an apparatus and method for acquiring and utilizing shipping data, and more particularly to an apparatus for collecting information associated with a package, its sender and/or its recipient.

### BACKGROUND

Tracking packages from pickup to delivery is an ongoing problem faced by shipping companies. A variety of tags have been utilized in an attempt to track packages in a shipping system. Such tags include bar codes or symbols printed on stickers that are affixed to packages and RFID tags attached to packages. However, no matter what kind of tag is used to track a package, the shipping system breaks down at the last few feet of the package's journey: from the delivery truck to the recipient. Human error in delivery is still present regardless of the complexity or robustness of the system for tracking the tags on the packages. The tags become useless if the package is left on the wrong doorstep, delivered to the wrong recipient, or otherwise delivered out of the shipping system such that the shipper loses control over it and can no longer read the tags.

Package tracking is particularly important when restricted goods are shipped. Restricted goods include alcoholic beverages such as wine shipped from a producer or retailer to a buyer. Restricted goods also include prescription drugs shipped to a patient's home. Prescription drugs that are shipped in commerce include Ritalin and other narcotics, which can be sold or used illicitly if they are delivered to the wrong address. Currently, no system, device or method exists for positively identifying the receiver of a package and/or the age of that receiver. In a letter to the editor of The New York Times dated Jun. 13, 2004, the president and chief executive of the Wine and Spirits Wholesalers of America (WSWA), Juanita Duggan, wrote that “[h]arried truck drivers leaving alcohol on doorsteps should never replace licensed retailers checking ID's across the counters.” Although this statement by the WSWA reflects its own economic self-interest in preventing consumers from bypassing the wholesaler system, it identifies a problem in the shipment of restricted goods within or between states. As a result, restricted goods may potentially find their way into the hands of those who should not have them, which can result in liability to the shipper. Further, the potential that restricted goods will be wrongly delivered inhibits customers from shipping them, thereby reducing the potential revenue of the shipper. As state legislatures and federal courts move toward allowing more freedom to ship wine within and between states, and as the aging population increasingly receives prescription drugs via home delivery, ensuring that such shipments remain in the hands of those who are allowed to possess them is increasingly important.

### BRIEF DESCRIPTION OF THE DRAWINGS

FIG. 1 is a schematic view of an exemplary shipping information acquisition device (SIAD) that includes an identity verification system, entry condition verification system, package analysis system, and a delivery condition verification system.

FIG. 2 is a schematic view of a remote site with which the SIAD of FIG. 1 may communicate.

FIG. 3 is a schematic view of an exemplary composite data record.

FIG. 4 is a flowchart showing an exemplary use of the SIAD of FIG. 1 during delivery of a package to a recipient.

FIG. 5 is a flowchart showing an exemplary use of the SIAD of FIG. 1 during receipt of a package from a sender.

FIG. 6 is a flowchart showing exemplary tracking of data stored in one or more composite data records such as shown in FIG. 3.

### DETAILED DESCRIPTION

Referring to FIG. 1, an exemplary shipping information acquisition device (SIAD) 2 is shown. The SIAD 2 includes or is operationally connected to an information handling system 4. The information handling system 4 may be and/or include a microprocessor, an integrated circuit, an application-specific integrated circuit (ASIC), a printed circuit board, a router, or any other device capable of processing and/or transferring data in any form. The information handling system 4 may process data. In addition, or instead, the information handling system 4 may transfer data among one or more components of the SIAD 2. In addition, or instead, the information handling system 4 may transfer data from one or more components of the SIAD 2 to an external device for processing, such as via a communication interface 18 that is described in greater detail below. The information handling system 4 may include any appropriate operating system (such as LINUX, UNIX, Microsoft's WINDOWS CE® operating system, the PALM® operating system, or Wind River's VXWORKS® operating system) and/or software for operating itself and/or manipulating data. The information handling system 4 may be configured to receive and/or manipulate data in any suitable form, both in terms of the information content of that data and the electromagnetic form of that data.

A data storage system 6 may be operationally connected to the information handling system 4. The data storage system 6 may include any structure or mechanism that is configured to store data temporarily or permanently in any suitable form. For example, the data storage system 6 may include one or more of a hard disk drive, flash memory, random access memory, dynamic random access memory (DRAM), non-volatile random access memory (NVRAM), analog memory, a compact disc and an associated drive, a removable disk and its associated drive, and/or any other suitable device. The data storage system 6 may be located within the SIAD 2. If so, the data storage system 6 may be connected directly to the information handling system 4 in any suitable manner, such as by one or more traces on a printed circuit board, one or more wires, a wireless connection, and/or any other suitable structure, mechanism and/or method. A direct connection is shown in FIG. 1 for clarity, although FIG. 1 does not limit the connection between the data storage system 6 and the information handling system 4 to a direct connection; all connections and their topology shown in FIG. 1 are merely exemplary. Alternately, the data storage system 6 may be connected to the information handling system 4 indirectly, such as by a bus. Any suitable bus may be utilized, such as a standard peripheral component interconnect (PCI) bus, a standard PCI extensions for instrumentation (PXI) bus, and/or a custom or proprietary bus. Alternately, the data storage system 6 is located outside the SIAD 2. If so, the information handling system 4 and/or one or more other components of the SIAD 2 may communicate with the data storage system 6 via the communication interface 18 or other device or method. Indeed, one or more of the components of the SIAD 2 described in this document may be smaller and/or standalone devices linked via a wireless connection protocol such as Bluetooth.

An identity verification system 8 may be operationally connected to the information handling system 4. As used in this document, the phrase “identity verification system” means any mechanism or mechanisms, structure or structures, or combination thereof that is configured to acquire identity information (such as a name and/or age) regarding a person associated with a package 9, such as from an identification document. For clarity, the package 9 is not necessarily shown to scale in FIG. 1. Advantageously, the identity verification system 8 is configured to positively identify the name and/or age of a recipient associated with a package 9 before transferring custody of a package to that person. The identity verification system 8 may include a card reader or other magnetic stripe reader configured to read the magnetic stripe on a drivers' license, national identity card, next-generation Social Security Card, internal passport, credit card, or other card or form of privately-issued or government-issued identification. Any of such items may be referred to as “identification documents” in this document. The card reader 8 may be configured to read data stored in a common format mandated by the federal government on the magnetic stripe on a state-issued drivers' license. As one example, the card reader 8 may be the Mini Swipe Card Reader sold by Magtek. As another example, the card reader 8 may be the MT-215 Insert Card Reader sold by Magtek. Any suitable card reader 8 may be used, whether it reads the card by swiping, by inserting or by any other mode of action. The identity verification system 8 may include a reader configured to read any other information stored on a card or form of government-issued identification, such as biometric information stored in a passport. The identity verification system 8 may include a digital camera. The identity verification system 8 may include at least one biometric scanner configured to gather biometric information about a person associated with a package, such as a fingerprint scanner, retinal scanner, gene chip, DNA analyzer, and/or any other mechanism, device or system that is capable of acquiring biometric data. Such biometric information may then be compared against the biometric information obtained from the person's passport or other documentation, such as by the information handling system 4. The identity verification system 8 may include a radio frequency identification device (RFID) reader capable of reading an RFID tag that is included in a privately-issued card or a government-issued identity document, or that is implanted in a person, such as the VeriChip implant of Applied Digital Solutions of Palm Beach, Fla. The identity verification system 8 may be configured to read multiple forms of identification, and/or to identify a person associated with a package 9 in two or more different ways, in order to positively identify that person. The identity verification system 8 may be used to acquire information regarding the identity of the person presenting a package 9 for entry into a shipping system, regarding the identity of a recipient of a package 9, or any other person.

The identity verification system 8 may be located on and/or within the SIAD 2. If so, the identity verification system 8 may be connected directly to the information handling system 4 in any suitable manner, such as by one or more traces on a printed circuit board, one or more wires, a wireless connection, and/or any other suitable structure, mechanism and/or method. A direct connection is shown in FIG. 1 for clarity, although FIG. 1 does not limit the connection between the identity verification system 8 and the information handling system 4 to a direct connection. Alternately, the identity verification system 8 may be connected to the information handling system 4 indirectly, such as by a bus. Any suitable bus may be utilized, such as a standard peripheral component interconnect (PCI) bus, a standard PCI extensions for instrumentation (PXI) bus, and/or a custom or proprietary bus. Alternately, the identity verification system 8 is located outside the SIAD 2. If so, the information handling system 4 and/or one or more other components of the SIAD 2 may communicate with the identity verification system 8 via the communication interface 18 or other device or method.

A delivery information acquisition system 10 may be operationally connected to the information handling system 4. As used in this document, the phrase “delivery information acquisition system” means any mechanism or mechanisms, structure or structures, or combination thereof that is configured to acquire information regarding a package 9 upon its delivery. Such information may include the condition of the package 9 upon delivery, where such condition information may include one or more photographs and/or video clips of the package 9. Such information may also include the location of the package 9 upon delivery, where such location information may include satellite positioning coordinates (e.g., Global Positioning System (GPS) coordinates, Galileo coordinates, GLONASS coordinates) or one or more photographs and/or video clips of the package 9 in a location where it was delivered. The delivery information acquisition system 10 may include a still camera, such as a digital camera. The delivery information acquisition system 10 may include a video camera, such as a digital video camera. A single camera may acquire both still and moving images. The delivery information acquisition system 10 may include at least one satellite positioning system receiver such as a GPS sensor, a Galileo sensor and/or a GLONASS sensor. The delivery information acquisition system 10 may include an RFID sensor or other sensor or receiver configured to receive information from a secure verified delivery point into which the package 9 is delivered. Such a verified delivery point may include an RFID chip or other unique identifier.

The delivery information acquisition system 10 may be located on and/or within the SIAD 2. If so, the delivery information acquisition system 10 may be connected directly to the information handling system 4 in any suitable manner, such as by one or more traces on a printed circuit board, one or more wires, a wireless connection, and/or any other suitable structure, mechanism and/or method. A direct connection is shown in FIG. 1 for clarity, although FIG. 1 does not limit the connection between the delivery information acquisition system 10 and the information handling system 4 to a direct connection. Alternately, the delivery information acquisition system 10 may be connected to the information handling system 4 indirectly, such as by a bus. Any suitable bus may be utilized, such as a standard peripheral component interconnect (PCI) bus, a standard PCI extensions for instrumentation (PXI) bus, and/or a custom or proprietary bus. Alternately, the delivery information acquisition system 10 is located outside the SIAD 2. If so, the information handling system 4 and/or one or more other components of the SIAD 2 may communicate with the delivery information acquisition system 10 via the communication interface 18 or other device or method.

An entry information acquisition system 12 may be operationally connected to the information handling system 4. As used in this document, the phrase “entry information acquisition system” means any mechanism or mechanisms, structure or structures, or combination thereof that is configured to acquire information regarding a package 9 upon its entry into a shipping system and/or regarding the identity of the person presenting a package 9 for entry into a shipping system. Such information may include the condition of the package 9 upon entry, where such condition information may include one or more photographs and/or video clips of the package 9. Such information may also include the location of the package 9 upon entry, where such location information may include satellite positioning coordinates (e.g., Global Positioning System (GPS) coordinates, Galileo coordinates, GLONASS coordinates) or one or more photographs and/or video clips of the package 9 in a location where it was delivered. The entry information acquisition system 12 may include any or all of the components described above with regard to the delivery information acquisition system 10. Advantageously, a separate entry information acquisition system 12 is not used, and the delivery information acquisition system 10 performs the functions of the entry information acquisition system 12. In this way, the overall size, cost and complexity of the SIAD 2 are reduced.

The entry information acquisition system 12 may be located on and/or within the SIAD 2. If so, the entry information acquisition system 12 may be connected directly to the information handling system 4 in any suitable manner, such as by one or more traces on a printed circuit board, one or more wires, a wireless connection, and/or any other suitable structure, mechanism and/or method. A direct connection is shown in FIG. 1 for clarity, although FIG. 1 does not limit the connection between the entry information acquisition system 12 and the information handling system 4 to a direct connection. Alternately, the entry information acquisition system 12 may be connected to the information handling system 4 indirectly, such as by a bus. Any suitable bus may be utilized, such as a standard peripheral component interconnect (PCI) bus, a standard PCI extensions for instrumentation (PXI) bus, and/or a custom or proprietary bus. Alternately, the entry information acquisition system 12 is located outside the SIAD 2. If so, the information handling system 4 and/or one or more other components of the SIAD 2 may communicate with the entry information acquisition system 12 via the communication interface 18 or other device or method.

The SIAD 2 may include a package analysis system 14. The package analysis system 14 is any mechanism or mechanisms, structure or structures, device or devices, method or methods, or combination thereof that is configured to acquire information regarding the contents of a package 9. The package analysis system 14 may include a trace detector, such as the SABRE 4000® of Smiths Detection plc of London, England. The package analysis system 14 may include an electronic nose, such as the VaporLab of Microsensor Systems, Inc. of Orlando, Fla. An electronic nose is an instrument used to detect vapors or chemical analytes in gases, solutions, and solids. An exemplary electronic nose is described in U.S. Pat. No. 6,085,576 to Sunshine et. al., which is hereby incorporated by reference in its entirety. The package analysis system 14 may include a mass spectrograph. The package analysis system 14 may include an ultrasonic sensor, an active or passive X-ray sensor, a millimeter wave scanner, an active or passive positron sensor, a computerized tomography device, or any other active or passive sensor. Optionally, the package analysis system 14 may be part of the entry information acquisition system 12.

The package analysis system 14 may be located on and/or within the SIAD 2. If so, the package analysis system 14 may be connected directly to the information handling system 4 in any suitable manner, such as by one or more traces on a printed circuit board, one or more wires, a wireless connection, and/or any other suitable structure, mechanism and/or method. A direct connection is shown in FIG. 1 for clarity, although FIG. 1 does not limit the connection between the package analysis system 14 and the information handling system 4 to a direct connection. Alternately, the package analysis system 14 may be connected to the information handling system 4 indirectly, such as by a bus. Any suitable bus may be utilized, such as a standard peripheral component interconnect (PCI) bus, a standard PCI extensions for instrumentation (PXI) bus, and/or a custom or proprietary bus. Alternately, the package analysis system 14 is located outside the SIAD 2. If so, the information handling system 4 and/or one or more other components of the SIAD 2 may communicate with the package analysis system 14 via the communication interface 18 or other device or method.

The SIAD 2 may include a package identification scanner 15. The package identification scanner 15 is any mechanism or mechanisms, structure or structures, device or devices, method or methods, or combination thereof that is configured to identify a package 9. As one example, the package identification scanner 15 is a laser scanner configured to read a barcode such as a one-dimensional barcode or a two-dimensional barcode. Such a barcode may be placed on a sticker which is placed on a package 9, where that barcode uniquely identifies the package 9 within the shipping system. As another example, the package identification scanner 15 is an RFID reader configured to read an RFID chip. Such an RFID chip may be attached to a package 9, where that RFID chip uniquely identifies the package 9 within the shipping system.

The package identification scanner 15 may be located on and/or within the SIAD 2. If so, the package identification scanner 15 may be connected directly to the information handling system 4 in any suitable manner, such as by one or more traces on a printed circuit board, one or more wires, a wireless connection, and/or any other suitable structure, mechanism and/or method. A direct connection is shown in FIG. 1 for clarity, although FIG. 1 does not limit the connection between the package identification scanner 15 and the information handling system 4 to a direct connection. Alternately, the package identification scanner 15 may be connected to the information handling system 4 indirectly, such as by a bus. Any suitable bus may be utilized, such as a standard peripheral component interconnect (PCI) bus, a standard PCI extensions for instrumentation (PXI) bus, and/or a custom or proprietary bus. Alternately, the package identification scanner 15 is located outside the SIAD 2. If so, the information handling system 4 and/or one or more other components of the SIAD 2 may communicate with the package identification scanner 15 via the communication interface 18 or other device or method.

The SIAD 2 may include a power source 16. The power source 16 may be any structure, mechanism or device that provides and/or transfers energy in any suitable form to the components of the SIAD 2. As one example, the power source 16 is a battery, whether rechargeable or not. As another example, the power source 16 is a fuel cell. As another example, the power source 16 is a connector or cord that connects to an AC or DC power outlet, port or jack. As another example, the power source 16 is an inductive coil or other inductive device that is capable of drawing electric power from a source outside the SIAD 2 for use by the components of the SIAD 2.

The power source 16 may be located on and/or within the SIAD 2. If so, the power source 16 may be connected directly to the information handling system 4 and the other components of the SIAD 2 in any suitable manner, such as one or more wires, by one or more traces on a printed circuit board, and/or any other suitable structure, mechanism and/or method. A direct connection is shown in FIG. 1 for clarity, although FIG. 1 does not limit the connection between the power source 16 and the information handling system 4 to a direct connection. Alternately, the power source 16 may be connected to the information handling system 4 indirectly, such as by a power bus. Alternately, the power source 16 is located outside of, and is operationally connected to, the SIAD 2.

The SIAD 2 may include a communications interface 18. The communication interface 18 may be any device capable of transferring data to and/or from the SIAD 2. As one example, the communication interface 18 may provide for wireless transmission of data from the SIAD 2 to one or more external devices and/or networks, and/or from one or more external devices and/or networks to the SIAD 2. For example, the communication interface 18 may transmit and/or receive data in any suitable portion of the electromagnetic spectrum, such as radio frequency (RF), infrared (IR), and/or microwave. Further, the communication interface 18 may utilize any appropriate transmission and/or network protocols, such as cellular phone protocols (e.g., GSM, PCS), time division-multiple access (TDMA), code-division multiple access (CDMA), general packet radio service (GPRS), Bluetooth, IEEE 802.11, and/or any other or additional suitable protocols. Other examples of a communication interface 18 are provided in U.S. Patent Application Publication No. 2003/0114206A1 of Timothy et. al. (“Timothy”), which is hereby incorporated by reference in its entirety. As another example, the communication interface 18 may include a mechanical interface that provide for wire-based transmission of data from the SIAD 2 and one or more external devices and/or networks, and/or from one or more external devices and/or networks to the SIAD 2. For example, the communication interface 18 may include a serial port, a CAT-5 jack, an IEEE 1394 FireWire port, or any other interface that allows connection of the SIAD 2 to an external device and/or network. As another example, the communication interface 18 may provide for both wireless and wire-based transmission of data from the SIAD 2 and one or more external devices and/or networks, and/or from one or more external devices and/or networks to the SIAD 2. In this way, the user may select the most advantageous mode of data transmission in a given situation. As another example, two or more separate communication interfaces 18 may be provided, each configured to transmit data from the SIAD 2 and one or more external devices and/or networks, and/or receive data from one or more external devices and/or networks to the SIAD 2, in a different manner.

The communication interface 18 may be located on and/or within the SIAD 2. If so, the communication interface 18 may be connected directly to the information handling system 4 in any suitable manner, such as by one or more traces on a printed circuit board, one or more wires, a wireless connection, and/or any other suitable structure, mechanism and/or method. A direct connection is shown in FIG. 1 for clarity, although FIG. 1 does not limit the connection between the communication interface 18 and the information handling system 4 to a direct connection. Alternately, the communication interface 18 may be connected to the information handling system 4 indirectly, such as by a bus. Any suitable bus may be utilized, such as a standard peripheral component interconnect (PCI) bus, a standard PCI extensions for instrumentation (PXI) bus, and/or a custom or proprietary bus. Alternately, the communication interface 18 is located outside the SIAD 2. If so, the information handling system 4 and/or one or more other components of the SIAD 2 may communicate with the communication interface 18 via another communication interface 18. For example, one communication interface 18 may be provided in the SIAD 2 that is useful for short-range data communication, and a second communication interface 18 may be provided outside of the SIAD 2, such as in a delivery truck, may be useful for long-range data communication.

The communication interface 18 may include and/or be connected to an antenna 24. The antenna 24 may be configured to transmit and/or receive data on any suitable portion of the electromagnetic spectrum. For example, the antenna 24 may be configured to transmit and/or receive data in the RF spectrum. As another example, the antenna 24 may include a sensor and/or transmitter configured to receive and/or send data in the infrared portion of the electromagnetic spectrum. Alternately, the antenna 24 may be configured to transmit and/or receive data in another form than present in the electromagnetic spectrum. The antenna 24 may be connected directly to the communication interface 18 in any suitable manner, such as by one or more traces on a printed circuit board, one or more wires, a wireless connection, and/or any other suitable structure, mechanism and/or method. A direct connection is shown in FIG. 1 for clarity, although FIG. 1 does not limit the connection between the communication interface 18 and the antenna 24 to a direct connection. Alternately, the communication interface 18 may be connected to the antenna 24 indirectly, such as by a bus. Any suitable bus may be utilized, such as a standard peripheral component interconnect (PCI) bus, a standard PCI extensions for instrumentation (PXI) bus, and/or a custom or proprietary bus.

The SIAD 2 may include a screen 20. The screen 20 may be any mechanism, structure or device that is capable of displaying information to a user. The screen 20 may be a liquid crystal display (LCD), cathode ray tube (CRT), plasma display, digital light processor (DLP) display, or any other suitable display. The screen 20 may be located on and/or within the SIAD 2. If so, the screen 20 may be connected directly to the information handling system 4 in any suitable manner, such as by one or more traces on a printed circuit board, one or more wires, a wireless connection, and/or any other suitable structure, mechanism and/or method. A direct connection is shown in FIG. 1 for clarity, although FIG. 1 does not limit the connection between the screen 20 and the information handling system 4 to a direct connection. Alternately, the screen 20 may be connected to the information handling system 4 indirectly, such as by a bus. Any suitable bus may be utilized, such as a standard peripheral component interconnect (PCI) bus, a standard PCI extensions for instrumentation (PXI) bus, and/or a custom or proprietary bus. Alternately, the screen 20 is located outside the SIAD 2. If so, the information handling system 4 and/or one or more other components of the SIAD 2 may communicate with the screen 20 via the communication interface 18 or other device or method.

The SIAD 2 may be portable. If so, the components of the SIAD 2 may be contained at least partially within, physically connected to, and/or operationally connected to a casing 22. Alternately, the SIAD 2 may be substantially stationary. If so, the casing 22 may be a kiosk 22. The kiosk 22 may be usable by a customer without assistance, and may be located in a post office, business, apartment building, hotel or other suitable location.

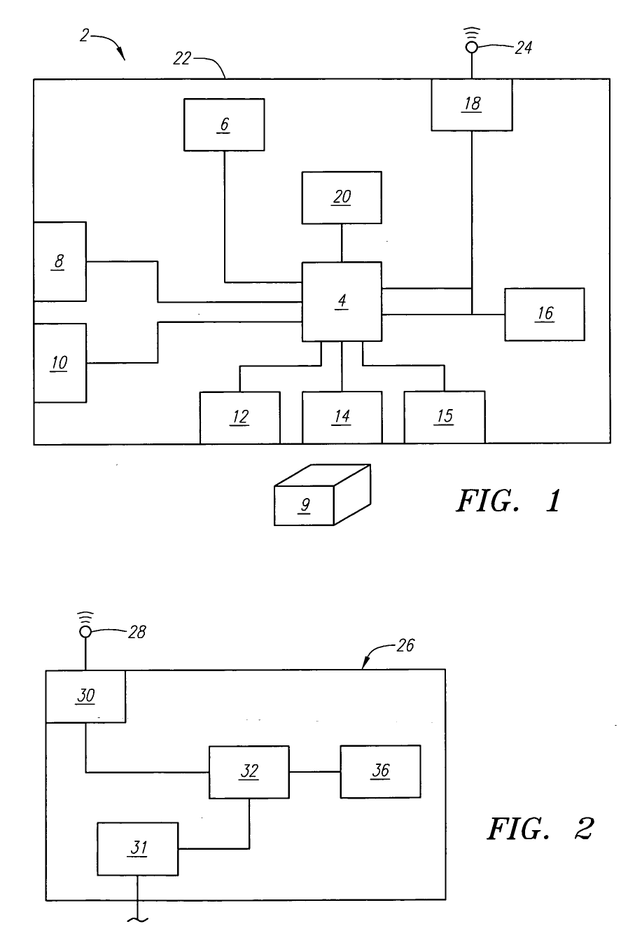

Referring also to FIG. 2, the SIAD 2 may communicate with at least one remote site 26 via the communication interface 18 and/or any other suitable structure, mechanism, device or method. The remote site 26 may include a remote site communication interface 30, similar to the communication interface 18, connected to an antenna 28. The remote site 26 may include at least one information handling system 32, which may be connected to the remote site communication interface 30. The remote site 26 may include a router 31 or other device that is connected to at least one information handling system 32 and to an external network such as the Internet, to a telephone system, or to any other data or communication network. In this way, data may be transmitted to and/or from the remote site 26 over a wired connection in addition to, or instead of, a wireless connection. Where multiple information handling systems 32 are present at the remote site 26, they may be networked in any suitable manner. Alternately, at least one information handling system 32 at the remote site 26 is not networked to one or more other information handling systems 32. Multiple remote sites 26 may be connected to one another in any suitable manner, such as via the Internet, via virtual private network, or other network.

Each information handling system 32 may be and/or include a microprocessor, an integrated circuit, a printed circuit board, a server, a router, or any other device capable of processing and/or transferring data in any form. Each information handling system 32 may be capable of processing data. In addition, or instead, the information handling system 32 may simply transfer data from one location to another within the remote site 26 and/or to another remote site 26. Each information handling system 32 may include any appropriate operating system (such as LINUX, UNIX, Microsoft's WINDOWS® operating system, or Sun's SOLARIS® operating system) and/or software for operating itself and/or manipulating data. The information handling system 32 may be configured to receive and/or manipulate data in any suitable form, both in terms of the information content of that data and the electromagnetic form of that data.

At least one data storage system 36 may be operationally connected to at least one information handling system 32 at a remote site 26. The data storage system 36 may include any structure or mechanism that is configured to store data temporarily or permanently in any suitable form. As one example, the data storage system 36 may be a storage area network (SAN). As another example, the data storage system 36 may be a network attached storage (NAS) system. As additional examples, the data storage system 36 may include one or more of a hard disk drive, flash memory, random access memory, dynamic random access memory (DRAM), non-volatile random access memory (NVRAM), analog memory, a compact disc and an associated drive, a floppy disk and its associated drive, and/or any other suitable device. Alternately, the data storage system 36 is used instead of at least one information handling system 32 at the remote site. Alternately, at least one remote site 26 does not include any information handling systems 32; rather, at least one data storage system 36 is utilized instead of the information handling systems 32. Alternately, where there are multiple remote sites 26, a single data storage system 36 may be shared among two or more remote sites 26.

The components of the SIAD 2 described above are exemplary. Different, additional or fewer components may be utilized. Further, the description of discrete components of the SIAD 2 or the remote site 26 does not require such components to be physically separated from one another; they may be integrated in any suitable manner. Further, functions identified as being performed by any particular component may instead be performed by a different component.

Composite Data Record

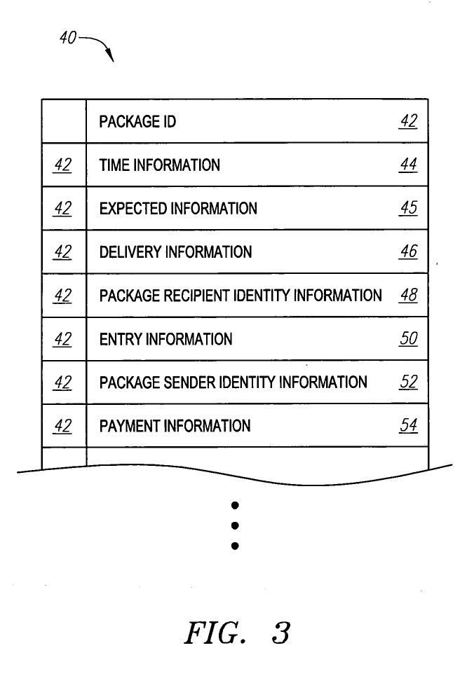

Referring to FIG. 3, the SIAD 2 and/or the remote site 26 is configured to generate and/or populate a composite data record (CDR) 40. As used in this document, the term “composite data record” refers to a quantity of information, in any form or forms, that includes one or more separate data entities associated with the delivery and/or pickup of a package 9. The CDR 40 and its constituent data entities may be created and stored in any form or forms, in any format or formats, and/or in any location or locations. As one example, CDR 40 may be one or more database entries in any form, such as a database table, file or relation. As another example, the CDR 40 may be a flat file in any suitable format. As another example, the CDR 40 may be any configuration of data that may be input into a relational database or other database. As another example, the CDR 40 may be a linked or hyperlinked compound document. As another example, the CDR 40 may include one or more pointers, where each pointer is associated with a separate data entity. As another example, the CDR 40 may be a data structure such as a list, linked list, or tree, and may include one or more pointers. As another example, at least one data entity within the CDR 40 may include one or more of an alphanumeric string, a numeric string, a static image file such as in GIF or JPEG format, a moving image or video file such as in AVI or Quicktime format, an audio file such as in MP3 format, and/or a document file in PDF format. The items below are exemplary data entities within the CDR 40. The CDR 40 may include less than all of those data entities, additional data entities, and/or different data entities.

The CDR 40 may include a package identifier 42 as one of its constituent data entities. The package identifier 42 may be a unique set of numbers, letters and/or other symbols. As one example, the package identifier 42 is a string of a fixed length composed of alphanumeric characters that may be systematically or randomly assigned to any particular transaction. The package identifier 42 uniquely identifies each package 9, and enables each particular transaction to be stored and later retrieved for any desired purpose, such as auditing or damage verification. Further, the use of a single unique package identifier 42 for each package 9 allows the different components of the CDR 40 to be stored separately, as described in greater detail below. The package identifier 42 need not be unique. As one example, package identifiers 42 may be reused after the passage of a particular amount of time (e.g., quarterly, yearly or after the passage of a different amount of time) or after a particular set of events or number of transactions. The package identifier 42 may be attached to the package 9, such as via a sticker or by direct printing on the package, and may be a barcode, RFID tag, or any other suitable identifier.

The CDR 40 may include time information 44 as one of its constituent data entities. The time information 44 may include the time and/or date at which the CDR 40 is opened. The time information 44 may be stored in any suitable format. Time information 44 may reference a standard time zone, such as Greenwich Mean Time (GMT), or may reference the time zone in which the CDR 40 was opened. Time information 44 may be stored as one or more separate entities within the CDR 40, and/or may be associated with other data entities in the CDR 40. Time information 44 may be associated with the package identifier 42 of the CDR 40 in any suitable manner; as one example, the package identifier 42 may be a header at the beginning of each element of time information 44 as shown in FIG. 2.

The CDR 40 may include one or more expected information records 45 as one or more of its constituent data entities. Each expected information record 45 may include any suitable information expected from the recipient upon delivery. For example, an expected information record 45 may include the name of the expected recipient, as provided by the sender. As another example, an expected information record 45 may include the minimum age of the recipient, such as where the package includes wine or alcohol. As another example, an expected information record 45 may include a flag indicating whether an identification check is required upon delivery. The flag indicating whether an adult signature is required upon delivery may be set at, for example, 0 for no, and 1 for yes. Optionally, the flag indicating whether an adult signature is required upon delivery may be a separate data entity within the CDR 40, outside the expected information record 45. Each expected information record 45 may be associated with the package identifier 42 of the CDR 40 in any suitable manner; as one example, the package identifier 42 may be a header at the beginning of each expected information record 45 as shown in FIG. 2.

The CDR 40 may include one or more delivery information records 46 as one or more of its constituent data entities. Each delivery information record 46 may include any suitable information associated with the package 9 upon its delivery. For example, a delivery information record 46 may include GPS data of the delivery location, a digital photograph of the package 9, a digital photograph of the package delivery location, and/or credit card transaction information. Thus, the delivery information records 46 may be in a number of different formats, and may be a number of separate records within the CDR 40.

The CDR 40 may include one or more package recipient identity information records 48 as one or more of its constituent data entities. Each recipient identity information record 48 may include any suitable information associated with the recipient of the package 9 upon delivery. For example, a recipient identity information record 48 may include a record of the receiver's name obtained by scanning an identification card, document or object possessed by the receiver, a record of the receiver's age obtained by scanning an identification document possessed by the receiver, a photograph of the receiver, and/or the signature of the receiver. Thus, the package recipient identity information records 48 may be in a number of different formats, and may be a number of separate records within the CDR 40. Each package recipient identity information record 48 may be associated with the package identifier 42 of the CDR 40 in any suitable manner; as one example, the package identifier 42 may be a header at the beginning of each package recipient identity information record 48 as shown in FIG. 2.

The CDR 40 may include one or more entry information records as one or more of its constituent data entities. Each entry information record 50 may include any suitable information about the package 9 identified by the CDR 40. For example, an entry information record 50 may include a flag indicating whether an adult signature is required upon receipt, GPS data of the pickup location, a digital photograph of the package 9, an ultrasonic image of the package 9, a record of an electronic nose scan of the package 9, a record of a trace detection performed on the package 9, an ultrasonic image of the package 9,.and/or a record of an electronic nose scan of the package 9. Thus, the package analysis records 50 may be in a number of different formats, and may be a number of separate records within the CDR 40. Each package analysis record 50 may be associated with the package identifier 42 of the CDR 40 in any suitable manner; as one example, the package identifier 42 may be a header at the beginning of each package analysis record 50 as shown in FIG. 2.

The CDR 40 may include one or more package sender identity information records 52 as one or more of its constituent data entities. Each package sender identity information record 52 may include any suitable information associated with the sender of the package 9. For example, a package sender identity information record 52 may include a record of the sender's identity obtained by scanning an identification card, document or object possessed by the sender, a record of the sender's age obtained by scanning an identification document possessed by the receiver, a photograph of the sender, and/or the signature of the receiver. Thus, the package sender identity information records 52 may be in a number of different formats, and may be a number of separate records within the CDR′40. Each package sender identity information record 52 may be associated with the package identifier 42 of the CDR 40 in any suitable manner; as one example, the package identifier 42 may be a header at the beginning of each package sender identity information record 52 as shown in FIG. 2.

The CDR 40 may include one or more payment information records 54 as one or more of its constituent data entities. Each payment information record 54 may include any suitable information associated with payment for the shipment of the package 9. For example, the payment information record 54 may include credit card information of the sender and/or recipient, a flag indicating that payment on delivery is required, and/or receipt information indicating that payment has been received. As another example, the payment information record 54 may include a flag indicating whether payment is required on delivery; that is, whether the delivery is “cash-on-delivery” (COD). The flag may be set, for example, at 0 for a non-COD delivery and 1 for a COD delivery. Alternately, the COD flag is a separate data entity within the CDR 40. The payment information records 54 may be in a number of different formats, and may be a number of separate records within the CDR 40. Each payment information record 54 may be associated with the package identifier 42 of the CDR 40 in any suitable manner; as one example, the package identifier 42 may be a header at the beginning of each payment information record 54 as shown in FIG. 2.

Operation-Receiving

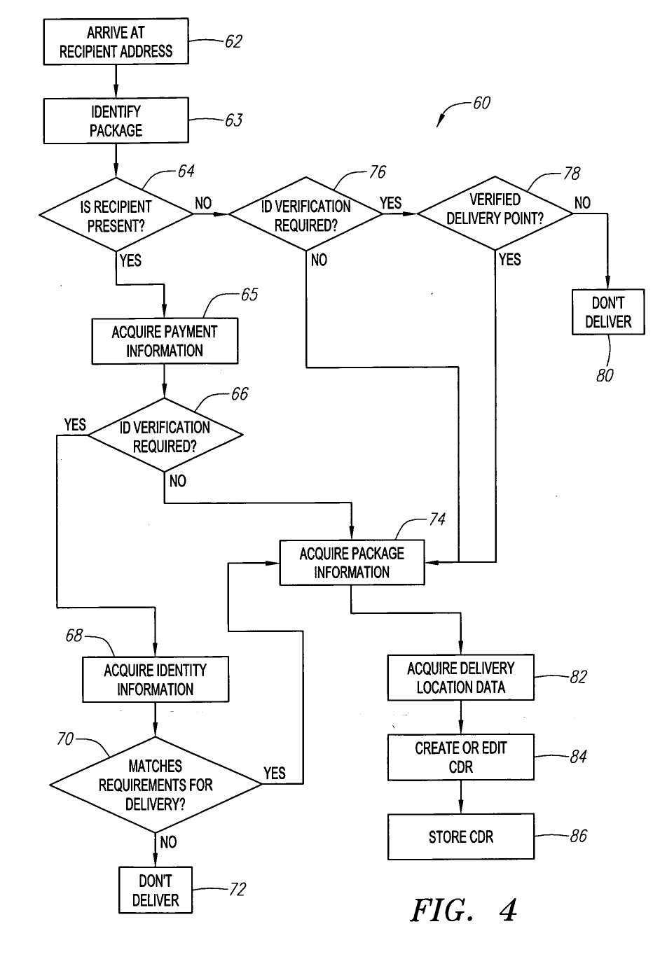

Referring to FIG. 4, an exemplary method 60 for utilizing the SIAD 2 in delivering a package 9 to a recipient is shown. The method begins at block 62, where a delivery person arrives at the address of the recipient, as set forth on the package 9 or otherwise determined. Next, in block 63, the delivery person identifies the package 9, such as by scanning an identifier such as a barcode attached to the package 9 with the package identification scanner 15 of the SIAD 2. The identifier on the package 9 scanned by the package identification scanner 15 may be the package identifier 42 or may be related to the package identifier 42. In this way, information associated with the package 9 (such as a CDR 40) may be accessed via the SIAD 2. Such access may be performed in any suitable manner. As one example, after the package identification scanner 15 scans a barcode or other signifier on the package 9 to determine the package identifier 42 associated with the package 9, the package identifier 42 is transmitted by the SIAD 2 through the communications interface 18 to a remote site 26. At the remote site, an information handling system 32 searches through stored CDRs 40 to locate the particular CDR 40 that includes that transmitted package identifier 42, then transmits that CDR 40 to the SIAD 2 via the remote site communications interface 30. As another example, as the delivery person's truck is loaded prior to delivering packages 9, each of the packages 9 loaded is scanned, and the CDR 40 associated with each such package is loaded into the data storage system 6 of the SIAD 2 that the delivery person will take along with that truck. The SIAD 2 may be connected to a cradle (not shown) which includes a detachable physical data connection, and the CDRs 40 associated with each package loaded into the truck may be loaded into the SIAD 2 via that connection. The CDR 40 associated with each package identifier 42 may be transmitted to, stored in, loaded into or otherwise delivered to the SIAD 2 in any other suitable manner. In this way, after the package 9 is uniquely identified, the CDR 40 associated with that package 9 may be loaded into the information handling system 4 or other suitable structure (e.g., random access memory) and/or software within the SIAD 2, such that the CDR 40 is available for suitable blocks of the method 60.

Next, in block 64, the delivery person determines whether the recipient is present. If the recipient is present, the method 60 moves to block 65, which is optional. In block 65, credit card information or other payment information may be acquired from the recipient. As described above, the payment information record 54, or other data entity within the CDR 40 associated with the package 9, may include a flag that indicates whether the delivery is COD; if it is, the SIAD 2 may display an alert or other message indicating that the delivery person is to collect payment from the recipient. As one example, the recipient's credit card is read by a card reader that is part of the identity verification system 8 of the SLID 2. As another example, the recipient's account number with the shipper may be entered into the SIAD 2. Such payment information may be stored in the payment information record 54 of the CDR 40. In this way, the delivery person may receive payment such as cash-on-delivery (COD) payment from a receiver. The process for shipping COD packages is thereby enhanced, allowing for COD packages to be shipped without the need for the driver or other parcel handler to carry or handle cash.

Next, the method 60 moves from block 65 to block 66, in which the delivery person determines whether verification of the recipient's identity and/or age is required for delivery. Such verification may be required where the package 9 includes restricted goods, such as alcoholic beverages or prescription drugs. The delivery person may determine whether such age and/or identity verification is required in any suitable manner. As one example, the CDR 40 associated with the package 9 to be delivered includes a delivery information record 46 that in turn includes a flag indicating that age and/or identity verification is required for delivery of the package 9. The flag may cause the requirement for age and/or identity verification to display a message on the screen 20 or any other suitable display apparatus. As another example, one or more stickers or identifiers may be placed on the package 9, indicating to the delivery person that age and/or identity verification is required before delivery of the package 9. As another example, an RFID tag or other tracking device associated with the package 9 may indicate to the delivery person that age and/or identity verification is required before delivery of the package 9. The SIAD 2 may be used to receive information from the RFID tag or other tracking device and display the age and/or identity requirement on the screen 20.

If the delivery person is required to verify the age and/or identity of the recipient, the process moves from block 66 to block 68. In block 68, the delivery person acquires data that positively verifies the age and/or identity of the recipient. The delivery person may acquire such data in any suitable manner. As one example, the recipient's drivers' license, national identity card, next-generation Social Security Card, internal passport, credit card, or other card or form of privately-issued or government-issued identification is read by a card reader that is part of the identity verification system 8 of the SIAD 2. Data stored in a magnetic stripe, computer chip, RFID tag or other data storage entity on the identification document or device is thus read by-the SIAD 2. As another example, the identity verification system 8 reads an RFID tag that is implanted in the recipient. As another example, the identity verification system 8 collects biometric data associated with the recipient, such as an image of the recipient, a fingerprint of the recipient, a DNA sample of the recipient, or other biometric data. As another example, the delivery person collects multiple forms of identification with the identity verification system 8 of the SIAD 2, such as data from a magnetic stripe on the recipient's drivers' license and a fingerprint of the recipient. Optionally, the SIAD 2 may communicate with at least one remote site 26 via the communication interface 18 and/or any other suitable structure, mechanism, device or method in order to compare biometric data or other data collected by the identity verification system 8 with data stored remotely in a database or in another form and thus positively identify the recipient. The identity and/or age of the recipient as determined by the identity verification system may be displayed on the screen 20, such that the delivery person can compare the recipient's name as determined by the identity verification system 8 with the name on the package 9 and/or in the delivery information record 46 of the CDR 40. Thus, such biometric data is not merely stored in the SIAD 2 or other system for later analysis, but rather is used to provide the delivery person with positive identification of the recipient. At least a portion of the data collected by the identity verification system 8 may be stored in the package recipient identity 48 of the CDR 40.

The process 60 then moves to block 70, where the delivery person determines whether the identity and/or age of the recipient as determined by the identity verification system 8 in block 70 matches the required identity and/or minimum age for delivery of the package 9. The expected information record or records 45 of the CDR 40 associated with the package 9 may include the expected name of the recipient and/or a minimum age for completing the delivery. As one example of block 70, the delivery person may view the screen 20 and determine if the name and/or age obtained from the identity verification system 8 matches the required identity and/or minimum age of the recipient for delivery of the package 9. The SIAD 2 may indicate if the age/or identity of the recipient as determined by the identity verification system 8 in block 70 matches the information stored within the expected information record or records 45 of the CDR 40 associated with the package 9, such as by flashing a warning on the screen 20, emitting a noise, or in any other desired manner. If the age and/or identity of the recipient as determined by the identity verification system 8 in block 70 matches the required identity and/or minimum age for delivery of the package 9, then the process 60 moves to block 74. If the age and/or identity of the recipient as determined by the identity verification system 8 in block 70 does not match the required identity and/or minimum age for delivery of the package 9, the process 60 moves to block 72, in which the delivery person does not deliver the package 9 to the recipient, and the process 60 stops.

If in block 66 the delivery person is not required to verify the age and/or identity of the recipient, the process moves from block 66 directly to block 74.

Returning to block 64, if the recipient is not present, the method moves from block 64 to block 76. In block 76, the delivery person determines whether age and/or identity verification is required for delivery of the package 9, in a manner such as described above with regard to block 66. If not, the process 60 moves to block 74. If so, the process 60 moves from block 76 to block 78. In block 78, the delivery person determines whether the recipient address has a verified delivery point. A verified delivery point may be a locker or other storage structure that includes a unique identifier that is uniquely openable by a recipient. For example, the verified delivery point may be a locker having an RFID tag uniquely associated with the recipient, where the locker includes a lock operable by the delivery person as well as the recipient. The unique identifier of the verified delivery point acts as a stand-in for the identity information such as name and age that would otherwise be provided by the recipient, such as in block 68. If the unique identifier of the verified delivery point matches the name of the recipient and/or the minimum age for delivery of the package 9, the process 60 moves from block 78 to block 74. If not, the process 60 moves from block 78 to block 80, in which the delivery person does not deliver the package 9 to the recipient, and the process 60 stops.

In block 74, the delivery person may acquire data about the package 9. Such data may be any suitable or useful data regarding the package 9 and/or the conditions of its delivery, and may be obtained in any suitable manner. At least a portion of the data collected by the delivery information acquisition system 10 may be stored in the delivery information record 46 of the CDR 40. As one example, the delivery information acquisition system 10 of the SIAD 2 captures one or more images of the package 9 upon delivery. The image or images may be still images, video clips, other types of images, and/or a combination thereof. In this way, a record may be made of the condition of the package 9 upon delivery.

Next, in block 82, the delivery person acquires data about the delivery location of the package 9. Such data may be any suitable or useful data regarding the location where the package 9 was delivered, and may be obtained in any suitable manner. At least a portion of the data collected by the delivery information acquisition system 10 may be stored in the delivery information record 46 of the CDR 40. As one example, the delivery information acquisition system 10 of the SIAD 2 captures one or more images of the location of the package delivery, such as the name of the business at which the package 9 was delivered, the house number or apartment number where the package 9 was delivered, or any other suitable images. Such package location information may be particularly useful where the package 9 has been left outside the door of the recipient in his or her absence, in order to prove the actual location at which the package 9 was deposited. As another example, the delivery information acquisition system 10 of the SIAD 2 captures location information such as satellite positioning coordinates upon delivery of the package 9. In this way, a record may be made of the location of the package 9 upon delivery. Such package location information may be particularly useful where the package 9 has been left outside the door of the recipient in his or her absence, in order to prove that the package 9 was deposited at the correct address. As another example, the delivery information acquisition system 10 of the SIAD 2 reads an RFID chip or other unique identifier from a secure receptacle into which the package 9 is delivered. In this way, a record may be made that the package 9 was delivered to a particular uniquely-identified secure receptacle.

Next, in block 84, the CDR 40 may be updated. The CDR 40 may be updated at any suitable time or times during the method 60, such that the actions of block 84 may be performed at any suitable time or times during the method 60, and are not limited to being performed after block 82. For example, the CDR 40 may be updated in each suitable block. As another example, the data collected in at least one block as described above is held temporarily in the information handling system 4 and/or the data storage system 6, then written to the CDR 40 in block 84.

Next, in block 86 the CDR 40 is stored. Such storage may be in any suitable location or locations. As one example, the CDR 40 is stored in the data storage system 6 of the SIAD 2. As another example, the CDR 40 is transmitted from the SIAD 2 to at least one remote site 26 via the communication interface 18, where the remote site 26 may store the CDR 40 in a data storage system 36 or other suitable device. The CDR 40 may be stored at any suitable time or times during the method 60, such that the actions of block 86 may be performed at any suitable time or times during the method 60, and are not limited to being performed after block 84. For example, the CDR 40 may be stored in each suitable block.

The blocks of the method 60 may be performed in a different order, as appropriate. Further, one or more of the blocks of the method 60 may be performed at the same time as one or more other blocks.

Alternately, referring to FIG. 4, in block 62 the recipient travels to a kiosk 22 at a central or other location to pick up the package 9. The central location may be a kiosk 22 or a staffed location. In such an alternate method, the method 60 moves directly from block 62 to block 68, in which the recipient establishes his or her identity. As one example, the recipient provides at least one form of identification to the kiosk 22, where the kiosk 22 includes one or more lockers, each of which may hold at least one package 9. Upon acquiring data that positively identifies the recipient in block 68, the kiosk 22 unlocks the locker that holds the package or packages 9 intended for the recipient. As another example, the recipient shows at least one form of identification to a person at a central location. In this alternate method, block 82 may be omitted, because the delivery location is known.

Operation—Sending

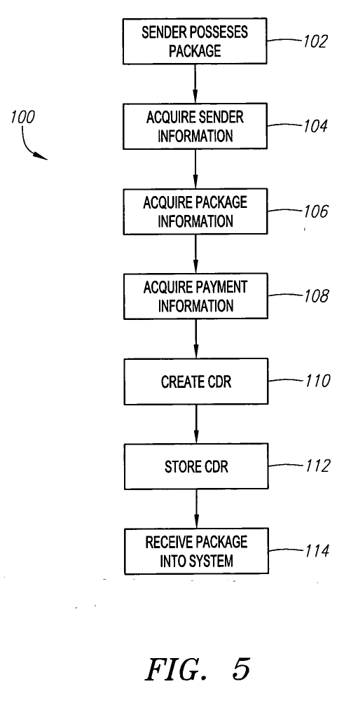

Referring to FIG. 5, an exemplary method 100 for utilizing the SIAD 2 in delivering a package 9 to a recipient is shown. This method 100 may be utilized whether the SIAD 2 is portable or is contained within a kiosk 22, and thus may be utilized whether the SIAD 2 is used by a delivery person, or by a sender at a staffed or unstaffed kiosk 22. The method 100 may be performed in addition to or instead of the method 60. In block 102 of the method 100, a sender has a package 9 for entry into the shipping system for shipment to a receiver. A delivery person may come to the sender's location, or the sender may take the package 9 to a kiosk 22 at a central or other location, such as a storefront, post office, or private mailbox business.

Next, in block 104, information about the sender may be acquired. Block 104 is optional. Information about the sender may be acquired in any suitable manner, such as described above with regard to block 68 of method 60, in order to positively identify the sender. For example, the identity verification system 8 of the SIAD 2 acquires data about the sender, such as the identity, age, and/or biometric data of the sender. Optionally, the SIAD 2 may communicate with at least one remote site 26 via the communication interface 18 and/or any other suitable structure, mechanism, device or method in order to compare biometric data or other data collected by the identity verification system 8 with data stored remotely in a database or in another form and thus positively identify the recipient. The identity and/or age of the recipient as determined by the identity verification system may be displayed on the screen 20. At least a portion of the data collected by the identity verification system 8 may be stored in the package sender identity information record 52 of the CDR 40.

Next, in block 106, information about the package 9 may be acquired. The entry information acquisition system 12 of the SIAD may be used to acquire such information. Alternately, the delivery information acquisition system 10 of the SIAD 2 may be used to acquire such information. As one example, the entry information acquisition system 12 may acquire one or more photographs and/or video clips of the package 9. As another example, the entry information acquisition system 12 may acquire location information associated with the package 9, such as satellite positioning coordinates and/or one or more photographs and/or video clips of the package 9 that identify its location, such as by showing a street number or other indicia of location. Also, or instead, in block 106 the package 9 may be analyzed by the package analysis system 14. As one example, the package analysis system 14 may include a trace detector, and is actuated to detect traces of explosive substances, drugs or other matter. As another example, the package analysis system 14 may include an electronic nose, which is actuated to detect explosive substances, drugs or other matter. As another example, the package analysis system 14 may include a mass spectrograph, which is actuated to detect explosive substances, drugs or other matter. As another example, the package analysis system 14 may include an ultrasonic transceiver and/or a millimeter wave transceiver, which is actuated to image the contents of the package 9. At least a portion of the data collected by the entry information acquisition system 12 and/or the package analysis system 14 may be stored in the entry information record 50 of the CDR 40. The parcel handler may refuse to accept the package 9 from the sender, if the package analysis system 14 indicates that the contents of the package 9 may be dangerous, illegal to possess or ship, or otherwise unacceptable. If so, the method 100 ends at block 106.

Optionally, in block 108 credit card information or other payment information may be acquired from the sender. As one example, the sender's credit card is read by a card reader that is part of the identity verification system 8 of the SIAD 2. As another example, the sender's account number with the shipper may be entered into the SIAD 2. Such payment information may be stored in the payment information record 54 of the CDR 40.

Next, in block 110 the CDR 40 associated with the package 9 may be updated or created. The CDR 40 may be created or updated at any suitable time or times during the method 100, such that the actions of block 108 may be performed at any suitable time or times during the method 100, and are not limited to being performed after block 106. For example, the CDR 40 may be updated in each suitable block. As another example, the data collected in at least one block as described above is held temporarily in the information handling system 4 and/or the data storage system 6, then written to the CDR 40 in block 108.

Next, in block 112 the CDR 40 is stored. Such storage may be in any suitable location or locations. As one example, the CDR 40 is stored in the data storage system 6 of the SLAD 2. As another example, the CDR 40 is transmitted from the SIAD 2 to at least one remote site 26 via the communication interface 18, where the remote site 26 may store the CDR 40 in a data storage system 36 or other suitable device. The CDR 40 may be stored at any suitable time or times during the method 100, such that the actions of block 112 may be performed at any suitable time or times during the method 100, and are not limited to being performed after block 110. For example, the CDR 40 may be stored in each suitable block. Next, in block 114, the package 9 is received into the shipping system.

The blocks of the method 100 may be performed in a different order, as appropriate. Further, one or more of the blocks of the method 100 may be performed at the same time as one or more other blocks.

Tracking

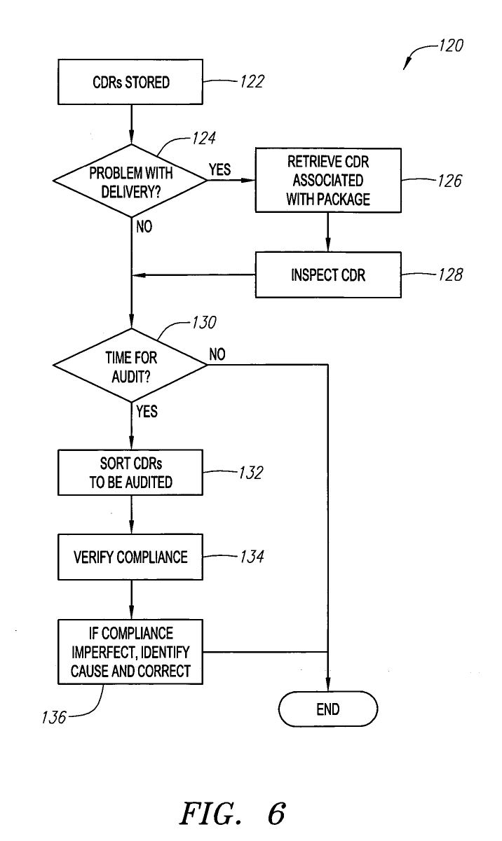

Referring to FIG. 6, an exemplary method 120 for tracking data associated with packages 9, their recipients and/or senders is shown. The method 120 is optional. In block 122, a plurality of CDRs 40 is stored. Such storage may be in any suitable location or locations. As one example, the CDRs 40 are stored in at least one data storage system 36 at one or more remote sites 26. The particular manner or location of storage of the CDRs 40 is not critical.

Next, in block 124, if a problem was associated with a particular package 9, the method moves to block 126. In block 126, the CDR 40 associated with that package 9 is retrieved from storage. That CDR 40 may be retrieved in any suitable manner, such as by database searching. Because a package identifier 42 is associated with each CDR 40, that package identifier 42 may be used to locate the CDR 40. For example, a database search for a particular package identifier 42 may be used to locate the CDR 40 associated with that package identifier 42. As another example, a database search for the name of a particular sender or receiver may bring up a list of package identifiers 42 or CDRs 40, and the particular transaction in which a problem was experienced may be selected from the list. Further, that CDR 40 may be retrieved by any suitable person. As one example, the CDR 40 may be retrieved by a representative of the shipper at a central location such as a call center or a storefront. As another example, the CDR 40 may be retrieved by a delivery person via the SIAD 2 and displayed on the screen 20 of the SIAD 2. As another example, the sender and/or receiver may view the CDR 40 associated with a package 9 via a web browser.

Next, in block 128, the records within the CDR 40 may be inspected to resolve the problem. As one example, the shipper may review the package recipient identity information record or records 48 of the CDR 40 to determine the identity of the person who received the package 9. If the package 9 was delivered to a person other than the intended recipient, the package recipient identity information record or records 48 positively identifies that person, such that the intended recipient can locate and retrieve the package 9 from that person or take any suitable action. If the package 9 was indeed delivered to the intended recipient, the package recipient identity information record or records 48 provides that information. In this way, fraud by a receiver who claims that he or she never received a package 9 that he or she actually did may be prevented.

As another example of inspecting the CDR 40 in block 128, if a receiver complains that an expected package 9 was never received, the shipper locates the CDR 40 associated with that package 9 in block 126 and inspects the records of that CDR 40 in block 128. For example, the shipper may review the delivery information record or records 46 of the CDR 40 to verify the location where the package 9 was delivered. If the package 9 was erroneously left in a location other than the address of the recipient, the delivery information record or records 46 will provide that information, such as via satellite positioning coordinates and/or one or more photos of the location in which the package 9 was left. If the package 9 was correctly delivered to the appropriate address, the delivery information record or records 46 provides that information as well.

As another example of inspecting the CDR 40 in block 128, if a receiver complains that a package 9 was delivered in a damaged condition, the shipper locates the CDR 40 associated with that package 9 in block 126 and inspects the records of that CDR 40 in block 128. For example, the shipper may review the delivery information block 46 of the CDR 40 to verify the condition of the package 9 upon delivery. If the package 9 was damaged prior to its delivery to the recipient, the delivery information block 46 will provide that information, such as via one or more photos or video clips of the package 9 upon its delivery. If the package 9 was not damaged prior to its delivery to the recipient, the delivery information block 46 provides that information. In this way, fraud by a receiver who claims that a package 9 was damaged prior to its delivery, when in fact it was not, may be prevented.

As another example of inspecting the CDR 40 in block 128, if a parent claims that a package 9 containing restricted goods such as alcohol was delivered to his or her child, the shipper may locate the CDR 40 associated with that package 9 in block 126 and inspects the records of that CDR 40 in block 128. As one example, the shipper may review the package recipient identity information record or records 48 of the CDR 40 to determine the identity of the person who received the package 9. If the package 9 was delivered to the recipient without positively identifying the recipient, the package recipient identity information record or records 48 may be blank or contain identity information that does not match the identity of the recipient. As another example, the flag in the delivery information record 46 indicating that recipient age information was to be collected may have been set incorrectly, or set correctly and ignored. The shipper can take the appropriate corrective action with regard to the delivery person who delivered the package 9 and/or with regard to any other deficiencies in the shipper's handling of packages 9 containing restricted goods. If the package 9 was delivered to an adult at the address of the recipient, the package recipient identity information block 48 provides that information.

As another example, if a receiver files an insurance claim that claims that the package 9 was never received or was damaged, the shipper may retrieve the CDR 40 associated with that package 9 in order to verify or deny that claim. Further, the CDR 40 associated with that package 9 may be provided to the appropriate law enforcement authorities responsible for investigating fraud.

The method 120 moves from either block 124 or 128 to block 130. In block 130, if it is time to conduct an audit of stored CDRs 40, the method continues to block 132. An audit is a process in which one or more data entities within one or more stored CDRs 40 are reviewed, manually or automatically, against one or more standards, laws, regulations, internal rules or other benchmarks. The audit may be conducted periodically, and/or on demand. By auditing stored CDRs 40 on a periodic or ongoing basis, such as daily or weekly, the shipper may verify that restricted goods have been properly delivered, and/or may verify compliance with applicable laws, regulations, standards or internal rules. If it is not time to conduct an audit of stored CDRs 40, the method ends.

In block 132, the CDRs 40 to be audited are retrieved in any suitable manner, such as described above with regard to block 126. For example, each CDR 40 that has in its delivery information record 46, or other component thereof, a flag indicating that the identity of the recipient must be positively established on delivery may be retrieved. As another example, a random subset of CDRs 40, or all CDRs 40, during a particular time period may be retrieved.

Next, in block 134, the CDRs 40 retrieved in block 132 are reviewed, automatically or manually, to ensure compliance with the shippers' procedures and/or governing law. As one example, in block 132 all of the CDRs 40 from a particular time period that indicate that the identity of the recipient must be positively established on delivery are retrieved. Such indications may be found in, for example, the expected information record 45 of each CDR 40, or in a different data entity within the CDR 40. Next, in block 134 the package recipient identity information record 46 of each CDR 40 retrieved in block 132 is reviewed. This review may be automatic, where the contents of the recipient identity information record 46 are compared to the recipient's name as stored in the expected information record 45 or other part of the CDR 40. Where the contents of the recipient identity information record 46 are the same as the recipient's name as stored in the expected information record 45 or other part of the CDR 40, no action need be taken. Where the contents of the recipient identity information record 46 are different from the recipient's name as stored in the expected information record 45 or other part of the CDR 40, or where the recipient identity information record 46 is blank or does not contain acceptable identity verification information, a report may be generated identifying that CDR 40.

As another example, in block 132 all of the CDRs 40 from a particular time period that indicate that the age of the recipient must be positively established on delivery are retrieved, such as by sorting on the expected information record or records 45 in the CDR 40 that indicate that age verification is required, or by sorting on a flag in the CDR 40 that indicates that age verification is required. Next, in block 134 the package recipient identity information record 46 of each CDR 40 retrieved in block 132 is reviewed. This review may be automatic, where the contents of the recipient identity information record 46 are compared to the recipient's required age as stored in the expected information record 45 or other part of the CDR 40. Where the contents of the recipient identity information record 46 indicate a value for age that is at least as large as the required age stored in the expected information record 45, no action need be taken. Where the age stored in the recipient identity information record 46 is different from the minimum age for delivery, such as stored in the expected information record 45, or where the recipient identity information record 46 is blank or does not contain acceptable age verification information, a report may be generated identifying that CDR 40.

As another example, in block 132 all of the CDRs 40 from a particular time period, such as the previous 24 hours, are retrieved. Next, in block 134 the delivery information record 46 of at least one CDR 40 is reviewed and compared against the time information record 44 of that CDR 40. The difference between these times is the amount of time that the shipper took to deliver the package 9. Where this amount of time is larger than expected for a particular package 9, a report may be generated identifying that CDR 40. Optionally, the entry information record 50 may be compared to the delivery information record 46 to determine the distance that the package 9 traveled. Also, or instead, a report may be generated that, for example, indicates the average amount of time spent by each package 9 in the shipping system, and or the average amount of time per mile of transit spent by each package 9 in the shipping system. Other metrics may be derived from auditing particular sets of CDRs 40. Optionally, block 132 is omitted, or performed simultaneously with block 134.

Next, in block 136, if the audit of block 134 determined that compliance was imperfect, the cause of such imperfect compliance can be determined and corrected. As one example, if a particular delivery person delivered a package 9 containing restricted goods to a person other than the intended recipient, or to a recipient who did not positively identify himself or herself, that delivery person may receive additional training on the proper handling of packages 9 containing restricted goods, and/or may receive discipline. In this way, liability of the shipper for failure of its delivery personnel to properly handle packages 9 containing restricted goods may be reduced, or eliminated altogether.

While the invention has been described in detail, it will be apparent to one skilled in the art that various changes and modifications can be made and equivalents employed, without departing from the present invention. It is to be understood that the invention is not limited to the details of construction, the arrangements of components and/or the details of operation set forth in the above description or illustrated in the drawings. Statements in the abstract of this document and in the summary, to the extent that the invention is summarized at any location in this document, are merely exemplary; they are not, and cannot be interpreted as, limiting the scope of the claims. Headings and subheadings are for the convenience of the reader only. They should not and cannot be construed to have any substantive significance, meaning or interpretation, and should not and cannot be deemed to be limiting in any way, or indicate that all of the information relating to any particular topic is to be found under or limited to any particular heading or subheading. The contents of each section of this document are merely exemplary and do not limit the scope of the invention or the interpretation of the claims. Therefore, the invention is not to be restricted or limited except in accordance with the following claims and their legal equivalents.

What is claimed is:

1. An apparatus utilized with a package transported from a sender to a receiver, comprising:
a shipping information acquisition device including an information handling system;
a data storage system operationally connected to said information handling system;
a package identification scanner operationally connected to said information handling system; and
an identity verification system operationally connected to said information handling system, said identity verification system configured to positively identify the receiver.

2. The apparatus of claim 1, wherein said identity verification system includes a magnetic stripe reader.

3. The apparatus of claim 1, wherein said identify verification system includes a radio frequency identification device reader.

4. The apparatus of claim 1, wherein said identity verification system includes a biometric sensor.

5. The apparatus of claim 1, wherein said shipping information acquisition device is portable.

6. The apparatus of claim 1, further comprising a delivery information acquisition system operationally connected to said information handling system.

7. The apparatus of claim 1, further comprising an entry information acquisition system operationally connected to said information handling system.

8. The apparatus of claim 1, further comprising a communication interface operationally connected to said information handling system.

9. The apparatus of claim 1, further comprising a package analysis system operationally connected to said information handling system.

10. A composite data record associated with a package transported from a sender to a recipient, comprising:
a package identifier; and
at least one package recipient identity information record, wherein at least one said package recipient identity information record is associated with said package identifier.

11. The composite data record of claim 10, wherein at least one said package recipient identity information record includes data associated with the age of the recipient.

12. The composite data record of claim 10, wherein at least one said package recipient identity information record includes data acquired from an identification document of the recipient.

13. The composite data record of claim 10, further comprising at least one payment information record, wherein at least one said payment information record is associated with said package identifier.

14. The composite data record of claim 10, further comprising at least one package sender identity information record, wherein at least one said package sender identity information record is associated with said package identifier.

15. The composite data record of claim 10, further comprising at least one expected information record, wherein at least one said package sender identity information record is associated with said package identifier.

16. The composite data record of claim 10, further comprising at least one of:
at least one delivery information record associated with said package identifier, and
at least one entry information record associated with said package identifier.

17. A method for tracking data associated with packages handled by a shipper, comprising:
assigning an identifier to each of a plurality of packages;
creating a composite data record corresponding to each said identifier; and
storing said composite data records.

18. The method of claim 17, further comprising inspecting at least one said composite data record.

19. The method of claim 18, further comprising selecting a plurality of said composite data records for auditing, wherein said inspecting is performed on said selected composite data records.

20. The method of claim 19, wherein each selected composite data record includes an expected information record and a package recipient identity information record; wherein said auditing includes comparing said expected information record to said package recipient identity information record.

21. The method of claim 10, wherein at least one said package recipient identity information record includes data acquired from an identification document of the recipient.
